(19) United States
(12) Patent Application Publication
(10) Pub. No.: US 2024/0157217 A1
(43) Pub. Date: May 16, 2024

(54) GOLF TEACHING METHOD AND GOLF TEACHING SYSTEM

(71) Applicant: INSTITUTE FOR INFORMATION INDUSTRY, Taipei City (TW)

(72) Inventors: CHENG-HUNG TSAI, TAIPEI CITY (TW); CHIA-YU JIH, TAIPEI CITY (TW); CHIH-CHUNG CHIEN, TAIPEI CITY (TW); LI-LIN LU, TAIPEI CITY (TW); SHAO-JUN TAN, TAIPEI CITY (TW); WEN-FU LAI, TAIPEI CITY (TW)

(21) Appl. No.: 18/137,152

(22) Filed: Apr. 20, 2023

(30) Foreign Application Priority Data
Nov. 14, 2022 (TW) 111143310

(51) Int. Cl. A63B 69/36; A63B 71/06; G06N 5/048; G06T 7/246

(52) U.S. Cl. CPC A63B 69/36; A63B 71/0622; G06N 5/048; G06T 7/251

(57) ABSTRACT

A golf teaching method and a golf teaching system are provided. The golf teaching method includes: configuring image capturing devices and golf simulator to capture swing images and corresponding simulator data records, when a user performs a golf swing; configuring an expert model that includes expert motion information and corresponding correction suggestion information; configuring a computing device to perform an analysis process on the swing images and the simulator data records to divide the golf swing into user motions according to stages and obtaining records of user motion information corresponding to the plurality of stages, and to compare the user motion information with the corresponding expert motion information in each stage through the expert model, and to provide the corresponding correction suggestion information according to a comparison result; and configuring a user interface to provide the correction suggestion information.

### CROSS-REFERENCE TO RELATED PATENT APPLICATION

This application claims the benefit of priority to Taiwan Patent Application No. 111143310, filed on Nov. 14, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a teaching method and a teaching system, and more particularly to a golf teaching method and a golf teaching system.

### BACKGROUND OF THE DISCLOSURE

When people learn to play golf, a golf simulator can analyze relevant data in response to a golfer swinging, such as a position of a hitting point, a swing angle, a swing trajectory, a trajectory of the golf ball, body movement changes and body rotation angles, which can be utilized for teachers and learners to scientifically adjust training processes, formulate training plans, and extend the personalized training process, thereby providing cross-domain services, such as reminders of common mistakes and golf hitting strategies.

In the existing golf teaching manner, the coach usually provides suggestions based on the coach's experience and observations on learners' posture, which lacks science quantification and knowledge evaluation in sports. In recent years, the golf simulator has been developed, which can analyze the user's movements and predict a flight path of the golf ball after being hit. However, there is still no complete golf teaching program. Therefore, it is important to digitize knowledge and experience and to integrate heterogeneous data, so as to provide auxiliary scientific knowledge guidance and improve experience in using sports technology services.

Therefore, improving the teaching method has become one of the important issues to be addressed.

### SUMMARY OF THE DISCLOSURE

In response to the above-referenced technical inadequacies, the present disclosure provides a golf teaching method and a golf teaching system capable of integrating heterogeneous data with expert knowledge to provide scientific guidance.

In one aspect, the present disclosure provides a golf teaching method, which includes: configuring a plurality of image capturing devices and a golf simulator to, when a user performs a golf swing, capture a plurality of swing images and a plurality of simulator data records corresponding to the plurality of swing images of the user; configuring a computing device to receive the plurality of swing images and the plurality of simulator data records; configuring an expert model that includes expert motion information and correction suggestion information that are corresponding to a plurality of stages in the golf swing; configuring the computing device to perform the following steps: performing an analysis process on the plurality of swing images and the plurality of simulator data records, so as to divide the golf swing into a plurality of user motions according to the plurality of stages, and obtaining a plurality of records of user motion information corresponding to the plurality of stages; and comparing the user motion information with the corresponding expert motion information in each of the plurality of stages through the expert model, and providing the corresponding correction suggestion information according to a comparison result. The golf teaching method further includes configuring a user interface to provide the correction suggestion information.

In another aspect, the present disclosure provides a golf teaching system, which includes a plurality of image capturing devices, a golf simulator, a computing device and a user interface. The plurality of image capturing devices and the golf simulator are configured to, when a user performs a golf swing, capture a plurality of swing images and a plurality of simulator data records corresponding to the plurality of swing images of the user. The computing device is configured to perform the following steps: receiving the plurality of swing images and the plurality of simulator data records; obtaining an expert model that includes expert motion information and correction suggestion information that are corresponding to a plurality of stages in the golf swing; performing an analysis process on the plurality of swing images and the plurality of simulator data records, so as to divide the golf swing into a plurality of user motions according to the plurality of stages, and obtaining a plurality of records of user motion information corresponding to the plurality of stages; and comparing the user motion information with the corresponding expert motion information in each of the plurality of stages through the expert model, and providing the corresponding correction suggestion information according to a comparison result. The user interface is configured to provide the correction suggestion information.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a golf teaching system according to one embodiment of the present disclosure;

FIGS. 2A and 2B are schematic configuration diagrams of a top camera, a side camera and a front camera according to one embodiment of the pre sent disclosure;

FIG. 3 is a flowchart of a golf teaching method according to one embodiment of the present disclosure;

FIG. 4 is a flowchart of an analysis process according to one embodiment of the present disclosure;

FIGS. 5A and 5B are schematic diagrams showing object recognition and tracking for a golf ball, a club face and a club according to one embodiment of the present disclosure;

FIGS. 6A and 6B are schematic diagrams showing a recognition for skeleton feature points being performed for body parts at swing positions P1 and P10, respectively;

FIG. 7 is a flowchart of a model establishing process for creating an expert model according to one embodiment of the present disclosure; and

FIG. 8 is a schematic diagram showing a membership function being defined according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of at least one synonym does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

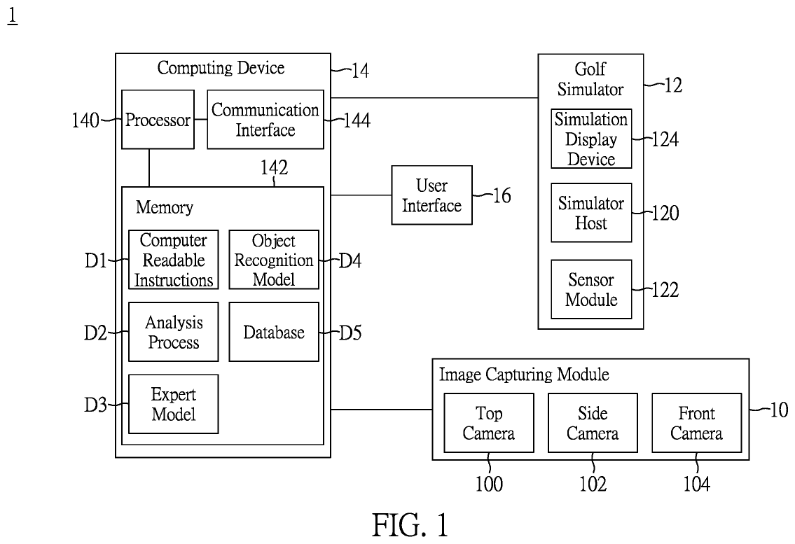

FIG. 1 is a functional block diagram of a golf teaching system according to one embodiment of the present disclosure. Reference is made to FIG. 1, a first embodiment of the present disclosure provides a golf teaching system 1, which includes an image capturing module 10, a golf simulator 12, a computing device 14 and a user interface 16.

The golf simulator 12 can be used to reproduce a golf course and simulate a trajectory of a golf ball, so as to provide a golfer with an experience of similar to actually playing golf on the golf course. In detail, the golf simulator 12 generally includes a simulator host 120, a sensor module 122, and a simulation display device 124. When a user performs a golf swing in an indoor simulator environment, multiple sensors included in the sensor module 122 can detect various ball hitting data of the user as simulator data, and send the simulator data back to the simulator host 120 to calculate possible speed, direction and trajectory, and then display the hit golf ball on the simulation display device 124 to display a travelling process of the golf ball in a virtual golf course. Specifically, the simulator data that can be obtained by the sensor module 122 can include a plurality of swing sensing data records, including at least one of ball speed, club head speed, launch direction, launch angle, club face angle, club path, spin directions such as back spin or side spin and hitting parameters. The above is merely examples, and the present disclosure is not limited thereto. In addition, the sensors can include at least one of optical sensors, speed sensors, force sensors, pressure sensors, temperature sensors, sound sensors, and acceleration sensors, and can be, for example, arranged on at least one of body parts of a user, a golf club, a golf ball, and surroundings of a hitting area, so as to realize sensing of the above-mentioned swing sensing data records.

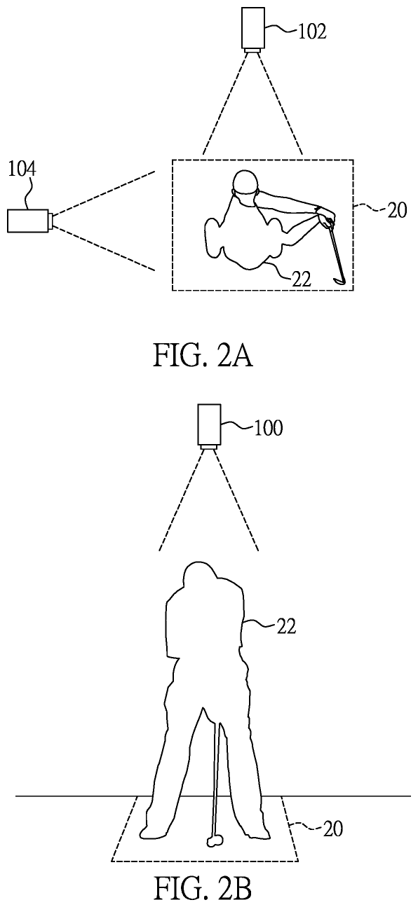

In some embodiments, the image capturing module 10 can include a plurality of image capturing devices, such as cameras or video cameras. FIGS. 2A and 2B are schematic configuration diagrams of a top camera, a side camera and a front camera according to one embodiment of the present disclosure. As shown in FIG. 2A and FIG. 2B, in one embodiment of the present disclosure, the image capturing module 10 can include, for example, a top camera 100, a side camera 102, and a front camera 104, which are respectively arranged above, in front of and on a side of a golf hitting area 20. The top camera 100, the side camera 102, and the front camera 104 can be used to obtain a top image, a front image and a side image of the user 22 standing in the golf hitting area 20 and performing golf swings, and these images must at least completely capture the golf ball, club and all parts of the body of the user 22 to provide a sufficient amount of data records for subsequent analysis. However, a location and a quantity of the image capturing devices included in the image capturing module 10 are not limited thereto. Furthermore, in some embodiments, the top camera 100, the side camera 102 and the front camera 104 can also be included in the golf simulator 12.

In some embodiments, the computing device 14 can be, for example, a general computer system or a server, and can include a processor 140, a memory 142 and a communication interface 144. Specifically, the processor 140 is electrically connected to the memory 142 and the communication interface 144. The processor 140 can include at least one processing unit, and can be, for example, a central processing unit (CPU) and/or a general-purpose microprocessor, a microcontroller, a digital signal processor (DSP), a field programmable gate array (FPGA), a programmable logic device (PLD), and a combination of any of the above devices that can perform data calculation or other operations, or any other suitable circuits, devices and/or structures.

In some embodiments, the memory 142 can be, for example, but not limited to, a hard disk, a solid-state disk, or other storage devices that can store data, which is configured to store at least a plurality of computer-readable instructions D1, an analysis process D2, an expert model D3, an object recognition model D4 and a database D5.

In some embodiments, the communication interface 144 can be, for example, a network interface card or an application programming interface (API), which is configured to communicate with the image capturing module 10, the golf simulator 12 and the user interface 16 under control of the processor 140, so as to obtain the aforementioned top image, front image, side image and simulator data, and to store them in the database D5.

For example, the user interface 16 can be a smart mobile device held by the user, and the smart mobile device can communicate with (or connect to) the computing device 14. After the smart mobile device executes a golf teaching application, a display of the smart mobile device can display the user interface 16. The user interface 16 can display golf teaching information provided by the computing device 14 and provide specific configuration options for the user to control golf teaching content to be displayed.

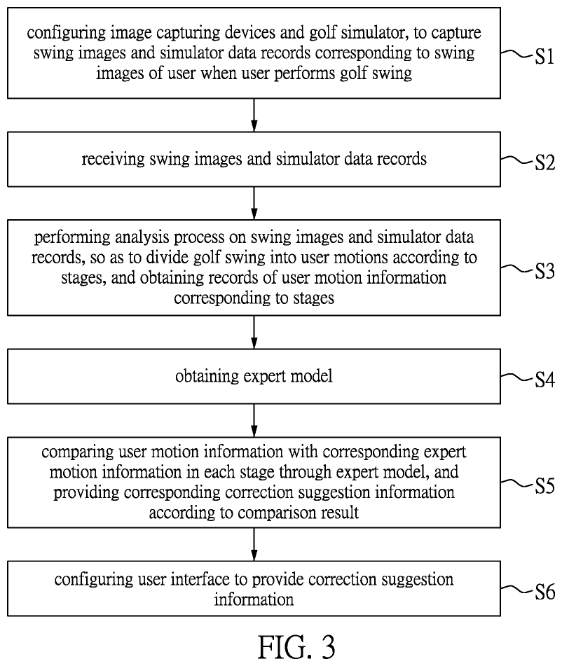

FIG. 3 is a flowchart of a golf teaching method according to one embodiment of the present disclosure. Reference is made to FIG. 3, one embodiment of the present disclosure also provides a golf teaching method, which is applicable to the aforementioned golf teaching system 1, but the present disclosure is not limited thereto. As shown in FIG. 3, the golf teaching method at least includes the following steps:

Step S1: configuring the image capturing devices and the golf simulator, to capture a plurality of swing images and a plurality of simulator data records corresponding to the plurality of swing images of a user when the user performs a golf swing.

Next, the golf teaching method includes configuring the computing device 14 to execute a plurality of computer-readable instructions D1 to perform the following steps:

Step S2: receiving the plurality of swing images and the plurality of simulator data records.

Step S3: performing an analysis process on the plurality of swing images and the plurality of simulator data records, so as to divide the golf swing into a plurality of user motions according to the plurality of stages, and obtaining a plurality of records of user motion information corresponding to the plurality of stages.

It should be noted that, through this step, the embodiment of the present disclosure combines the swing images and the sensor data in the simulator data to provide comprehensive three-dimensional information during the hitting process as the user motion information after the analysis process being performed. The user motion information can include, for example, hitting point feature information from a top perspective, swing feature information and ball path feature information from a side perspective, and body motion information from a frontal perspective.

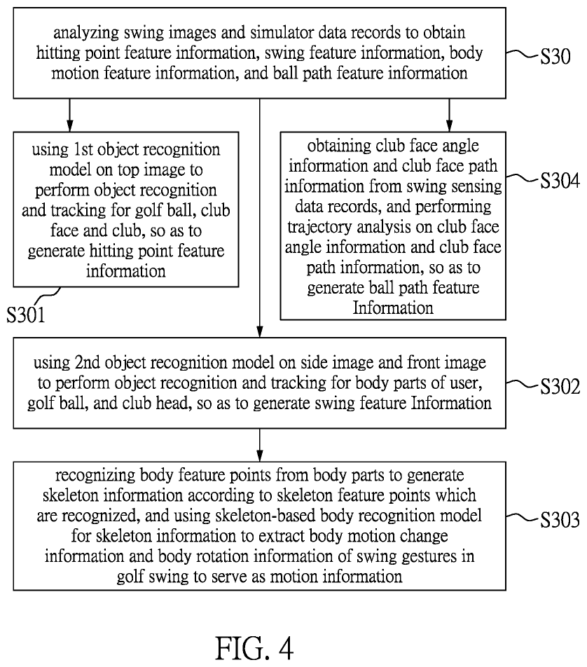

FIG. 4 is a flowchart of an analysis process according to one embodiment of the present disclosure. Reference is made to FIG. 4, the processor 140 can be configured to execute the analysis process D2, which includes the following steps:

Step S30: analyzing the swing images and the simulator data records to obtain hitting point feature information, swing feature information, body motion feature information, and ball path feature information.

In this step, for the hitting point feature information, step S301 can be performed: using a first object recognition model on the top image to perform object recognition and tracking for the golf ball, the club face and the club, so as to generate hitting point feature information. The first object recognition model can be included in the object recognition model D4, and can be, for example, a YOLO (You Only Look Once) v4 model.

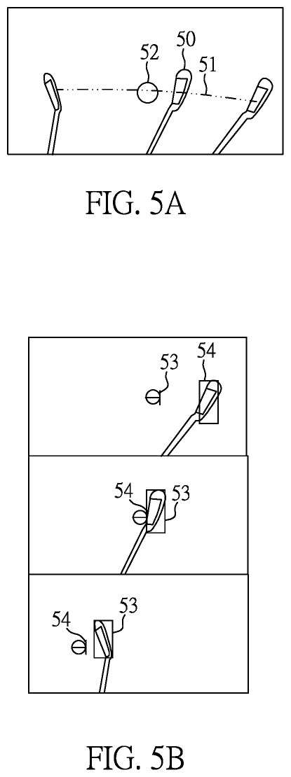

FIGS. 5A and 5B are schematic diagrams showing object recognition and tracking for a golf ball, a club face and a club according to one embodiment of the present disclosure. For example, as shown in FIG. 5A and FIG. 5B, a swing trajectory 51 of a club face 50 and an initial position of a golf ball 52 are depicted in FIG. 5A, and a plurality of top images are processed in FIG. 5B, such as through object frames 53 and 54, respectively, to identify and track the golf ball and the club face, and finally extract the hitting point feature information, including recognition for various club heads, recognition for the golf ball, and position analysis of various hitting points.

In addition, for swing feature information, step S302 can be performed: using the second object recognition model on the side image and the front image to perform object recognition and tracking for the body parts of the user, the golf ball, and the club head, so as to generate swing feature Information. For example, the swing feature information can include hitting area, swing angle, swing position analysis. It should be noted that the second object recognition model is also included in the object recognition model D4, and the step of using the second object recognition model to perform object recognition and tracking includes steps of performing object recognition and tracking of the golf club by using YOLOR, Mediapipe or other models, and a step of performing a recognition for skeleton feature points by using Mediapipe.

It should be noted that, in the above steps, when the swing motion is analyzed by the computing device 14, the recognition for the skeleton feature points can be performed on the body parts of the user in the front image and the side image according to a human body model, so as to generate the motion information.

In more detail, the step of performing the recognition for the skeleton feature points for the body parts of the user can include performing step S303: recognizing body feature points from the plurality of body parts to generate skeleton information according to the skeleton feature points which are recognized, and using a skeleton-based body recognition model for the skeleton information to extract change information of body motion and body rotation information of a plurality of swing gestures in the golf swing to serve as the motion information.

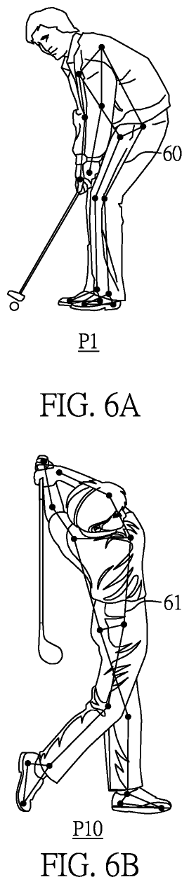

Reference is made to FIGS. 6A and 6B, FIGS. 6A and 6B are schematic diagrams showing a recognition for skeleton feature points being performed for body parts at swing positions P1 and P10, respectively. For example, as shown in FIGS. 6A and 6B, according to ten swing positions P1 to P10 defined by a golf P classification system, after skeleton information 60 is recognized from the body parts, the recognition model for skeleton feature points (such as Mediapipe) can be used to extract body motion information. For example, FIG. 6A shows a skeleton 60 extracted from the motion corresponding to the swing position P1, and FIG. 6B shows a skeleton 61 extracted from the motion corresponding to the swing position P10. Therefore, in step S303, since the motions of the swing positions are different, the body information can be divided into multiple stages according to different features of the swing positions in the change information of body motion and the body rotation information. In this case, the body motion information of each swing position can include change information of body motion (e.g., head lifting, body shifting and the like), body rotation information (e.g., a wrist bending angle, an angle between the arm and the body, and the like).

On the other hand, for the ball path feature information, step S304 can be performed: obtaining club face angle information and club face path information from the swing sensing data records, and performing trajectory analysis on the club face angle information and the club face path information, so as to generate the ball path feature Information. In detail, in step S304, the obtained club face angle information and club face path information can be combined with expert knowledge to analyze various ball path rules corresponding to different club face angles and club face paths. That is, in this step, according to correspondences among club face angle, club face path and ball path rules defined by the expert knowledge, the obtained club face angle information and club face path information can be classified to perform the trajectory analysis to determine ball path features. The ball path feature information can include, for example, information such as slice, left hook, flying too high, and/or not flying far for the golf ball that is hit by the user.

Reference is made to FIG. 3 again, the golf teaching method proceeds to step S4: obtaining an expert model. The expert model includes expert motion information and correction suggestion information that are corresponding to the stages in the golf swing.

In detail, the step S3 of obtaining the expert model can include executing a model establishing process to generate the expert model D3, and the purpose of this step is to digitize knowledge and experience.

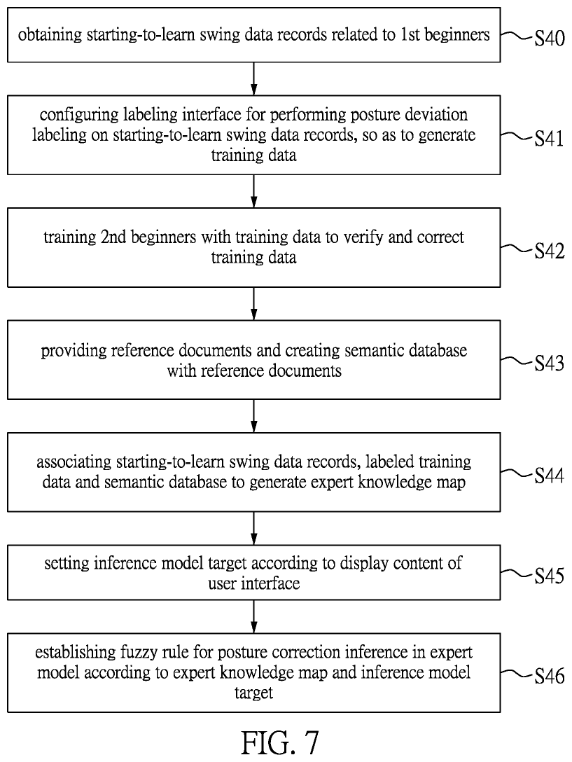

Reference is made to FIG. 7, which is a flowchart of a model establishing process for creating an expert model according to one embodiment of the present disclosure. As shown in FIG. 7, the model establishing process includes the following steps:

Step S40: obtaining starting-to-learn swing data records related to a plurality of first beginners. It should be noted that this step is a phase of generating training data. For example, 500 observation data records can be established based on hitting data (hitting information and video information associated with a 7-iron club) of 30 beginners (Group A). It should be noted that the observation data records include the user motion information of the multiple stages obtained in the aforementioned steps, and include hitting point feature information, swing feature information, body motion feature information, and ball path feature information.

Step S41: configuring a labeling interface for performing a posture deviation labeling on the plurality of starting-to-learn swing data records, so as to generate training data. This step is a phase of digitizing knowledge and experience. For example, multiple professional coaches can review the hitting videos, with corresponding observation data records of hitting, and then label deviations such as displacements and angles of the body parts or postures through the labeling interface, and then establish a golf knowledge graph. It should be noted that the labeling interface can, for example, provide hitting videos and corresponding batting observation data records through the aforementioned computing device 14 and a display device electrically connected to the computing device 14, and labeling content related to the posture deviation labeling can be inputted through input devices such as a keyboard and a mouse. The posture deviation labeling can be labeled for the stages in the golf swing, and can include corresponding common mistakes, detailed deviations of swing positions, and expert correction suggestions.

Step S42: training a plurality of second beginners with the training data to verify and correct the training data. For example, demonstrations can be conducted by another 30 beginners (group B), in which multiple rounds of demonstrations (3 times, each time with an interval of one month) are performed for rolling verification and correction of the training data.

Step S43: providing a plurality of reference documents and creating a semantic database with the reference documents. For example, interviews with professional coaches, players, and scholars can be used to create reference documents and a professional semantic database in the golf field can be created.

Step S44: associating the plurality of starting-to-learn swing data records, the labeled training data and the semantic database to generate a knowledge graph. For example, wrong hitting postures in the starting-to-learn swing data records can be associated with posture correction plans in the labeled training data, and heterogeneous data such as the wrong hitting postures, posture correction plans and professional terms or sports scientific theoretical descriptions in the semantic database can be associated with one another.

Step S45: setting an inference model target according to a display content of the user interface. For example, the expert model can be, for example, a fuzzy inference engine, and the golf teaching content to be provided in the user interface 16 can be used as the inference model target of the fuzzy inference engine. For example, the inference model target is to suggest correct posture corrections for each stage in the golf swing.

Step S46: establishing a fuzzy rule for posture correction inference in the expert model according to the knowledge graph and the inference model target. For example, since the knowledge graph established in the previous steps, input variables and output variables can be selected based on data in the knowledge graph.

In the above embodiments, multiple golf corpora in the semantic database can be converted into multiple semantic variables, and the input variables, output variables and corresponding value ranges are set with the semantic variables. For example, states of large joints, small joints, and minor joints of each body part during the golf swing of the user can be set as the input variables, and degree of deviation (for example, an angle) relative to a correct posture can be set as a corresponding value domain, while the output variable is a posture correction suggestion for incorrect postures, such as insufficient rotation of the shoulder, excessive hip bone rotation, or the right knee not kept bending, and is not limited herein.

In the above embodiment, when establishing fuzzy rules, a fuzzification step can be performed to form multiple fuzzy sets associated with the input variables and the output variables, and multiple membership functions can be defined according to the input variables and the output variables, so as to establish the fuzzy rule for the posture correction inference in the expert model.

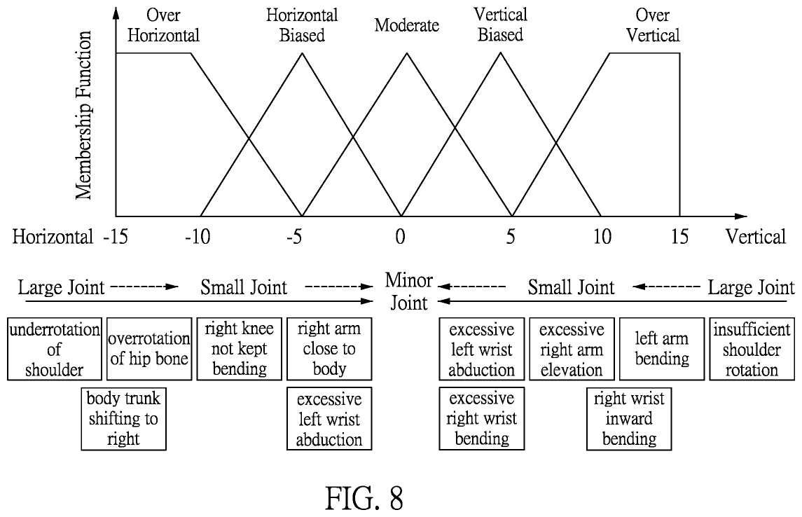

FIG. 8 is a schematic diagram showing a membership function being defined according to one embodiment of the present disclosure. Reference is made to FIG. 8, the membership function can be defined as shown in FIG. 8, in which a vertical axis corresponds to the membership function, and a horizontal axis corresponds to a degree of deviation of a specific joint part. For example, when the degree of deviation is less than zero, it represents a horizontal deviation, and a larger corresponding value represents a more severe horizontal deviation. When the degree of deviation is larger than zero, it represents a vertical deviation, and a larger corresponding value represents a more severe vertical deviation. Taking FIG. 8 as an example, when the state of a specific small joint corresponds to a horizontal deviation of −5 to −10 degrees, and a value of the membership function corresponding to the right leg not remaining bent is the highest in this interval, it can be inferred that the horizontal deviation is due to that the right leg is not kept bending. In this way, the fuzzy rule for the posture correction inference can be established. In addition, the posture correction suggestions can include right arm close to body, excessive left wrist abduction, excessive right arm elevation, left arm bending, insufficient shoulder rotation, body torso shifting to the right, excessive right wrist bending and/or right wrist inward bending, and is not limited herein.

Reference is made to FIG. 3 again, the golf teaching method proceeds to step S5: comparing the user motion information with the corresponding expert motion information in each stage through the expert model, and providing the corresponding correction suggestion information according to a comparison result.

Step S6: configuring a user interface to provide the correction suggestion information.

In steps S5 and S6, the expert model established in steps S40 to S48 can be used to provide correct posture correction suggestions for each stage of the golf swing, and the mobile device executing the golf teaching application can display the user interface 16. Golf teaching content displayed on the user interface 16 can include hitting information, posture error information, swing position information, expert-suggested correction information, hitting history analysis and/or personalized hitting strategy, and is not limited herein. For example, swing position information can include detailed motion analysis of 10 swing stages (rotation angles of head, shoulders, hands, waist, and/or feet), and posture error information can include eight types of error detection that users often make (push hook, push, push slice, hook, slice, pull hook, pull, pull slice). The expert-suggested correction information can provide correct motion guidance, allowing users to quickly understand and correct their postures, and also provide coaches for more accurate teaching assistance.

In conclusion, in the golf teaching method and the golf teaching method provided by the present disclosure, a teaching guidance system that combines heterogeneous data with expert knowledge is provided. By digitizing knowledge experience and combining heterogeneous data association, auxiliary scientific knowledge guidance can be provided, thereby improving an experience in using sports technology services.

In addition, the golf teaching method and the golf teaching system provided by the present disclosure can be introduced into any golf simulator, the user only needs to interact with the golf ball through the golf simulator, the golf teaching system can automatically analyze issues that need to be corrected for the user, including detailed analysis of various swing stages, detections of common mistakes, and guidance of correct motions, allowing users to quickly understand and correct their postures, and also provide coaches with more accurate teaching

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A golf teaching method, comprising:
configuring a plurality of image capturing devices and a golf simulator, to capture a plurality of swing images and a plurality of simulator data records corresponding to the plurality of swing images of a user when the user performs a golf swing;
configuring a computing device to receive the plurality of swing images and the plurality of simulator data records;
configuring an expert model that includes expert motion information and correction suggestion information that are corresponding to a plurality of stages in the golf swing;
configuring the computing device to perform the following steps:
performing an analysis process on the plurality of swing images and the plurality of simulator data records, so as to divide the golf swing into a plurality of user motions according to the plurality of stages, and obtaining a plurality of records of user motion information corresponding to the plurality of user motions; and
comparing the user motion information with the corresponding expert motion information in each of the plurality of stages through the expert model, and providing the corresponding correction suggestion information according to a comparison result; and
configuring a user interface to provide the correction suggestion information.

2. The golf teaching method according to claim 1, wherein the plurality of image capturing devices comprise:
a top camera for capturing at least one top image of the user performing the golf swing;
a side camera for capturing at least one side image of the user performing the golf swing; and
a front camera for capturing at least one front image of the user performing the golf swing.

3. The golf teaching method according to claim 2, wherein the analysis process comprises:
performing a recognition for skeleton feature points on the at least one front image and the at least one side image for a plurality of body parts according to a human body model, so as to generate the motion information.

4. The golf teaching method according to claim 3, wherein the step of performing the recognition for the skeleton feature points for the plurality of body parts comprises:
recognizing body feature points from the plurality of body parts to generate skeleton information according to the skeleton feature points which are recognized, and using a skeleton-based body recognition model for the skeleton information to extract change information of body motion and body rotation information of a plurality of swing positions in the golf swing to serve as the motion information.

5. The golf teaching method according to claim 4, wherein the step of performing the recognition for the skeleton feature points for the plurality of body parts further comprises:
dividing the motion information into the plurality of stages according to characteristics of the change information of body motion and the body rotation angle information of the swing fixed points.

6. The golf teaching method according to claim 1, further comprising:
executing a model establishing process to generate the expert model, wherein the model establishing process comprises:
obtaining a plurality of starting-to-learn swing data records related to a plurality of first beginners;
configuring a labeling interface for performing a posture deviation labeling on the plurality of starting-to-learn swing data records, so as to generate training data;
training a plurality of second beginners with the training data to verify and correct the training data;
providing a plurality of reference documents and creating a semantic database with the plurality of reference documents;
associating the plurality of starting-to-learn swing data records, the labeled training data and the semantic database to generate a knowledge graph;
setting an inference model target according to a display content of the user interface; and
establishing a fuzzy rule for posture correction inference in the expert model according to the knowledge graph and the inference model target.

7. The golf teaching method according to claim 6, wherein the expert model further comprises detailed information of swing gestures corresponding to the plurality of stages in the golf swing, and the golf teaching method further comprises: configuring the computing device to obtain detailed information of the swing gestures of the user by analyzing the plurality of swing images and the plurality of simulator data records, wherein the posture deviation labeling performed on the plurality of beginner swing data records by configuring the labeling interface comprises labeling of corresponding common mistakes, detailed deviations of the plurality of swing positions and the correction suggestion information.

8. The golf teaching method according to claim 1, wherein the expert model further comprises hitting point feature information corresponding to the golf swing, and the golf teaching method further comprises configuring the computing device to:
obtaining hitting point feature information during the user performing the golf swing by analyzing the plurality of swing images and the plurality of simulator data records; and
comparing the motion information of the user with the corresponding expert motion information and comparing the hitting point feature information of the expert model with the hitting point feature information of the user in each of the plurality of stages, so as to generate the comparison result.

9. The golf teaching method according to claim 1, wherein the expert model further comprises ball path feature information corresponding to the golf swing, and the golf teaching method further comprises: configuring the computing device to extract ball path information from the plurality of simulator data records of the golf simulator, to compare the user motion information with the corresponding expert motion information in each of the plurality of stages and to compare the ball feature information of the expert model with the ball path feature information of the golf simulator, so as to generate the comparison result.

10. A golf teaching system, comprising:
a plurality of image capturing devices and a golf simulator that are configured, to capture a plurality of swing images and a plurality of simulator data records corresponding to the plurality of swing images of a user when the user performs a golf swing;
a computing device configured to perform the following steps:
receiving the plurality of swing images and the plurality of simulator data records;
obtaining an expert model that comprises expert motion information and correction suggestion information that are corresponding to a plurality of stages in the golf swing;
performing an analysis process on the plurality of swing images and the plurality of simulator data records, so as to divide the golf swing into a plurality of user motions according to the plurality of stages, and obtaining a plurality of records of user motion information corresponding to the plurality of stages; and
comparing the user motion information with the corresponding expert motion information in each of the plurality of stages through the expert model, and providing the corresponding correction suggestion information according to a comparison result; and
a user interface configured to provide the correction suggestion information.

11. The golf teaching system according to claim 10, wherein the plurality of image capturing devices comprise:
a top camera for capturing at least one top image of the user performing the golf swing;
a side camera for capturing at least one side image of the user performing the golf swing; and
a front camera for capturing at least one front image of the user performing the golf swing.

12. The golf teaching system according to claim 11, wherein the analysis process comprises:
performing a recognition for skeleton feature points on the at least one front image and the at least one side image for a plurality of body parts according to a human body model, so as to generate the motion information.

13. The golf teaching system according to claim 12, wherein the step of performing the recognition for the skeleton feature points for the plurality of body parts comprises:
recognizing body feature points from the plurality of body parts to generate skeleton information according to the skeleton feature points which are recognized, and using a skeleton-based body recognition model for the skeleton information to extract change information of body motion and body rotation information of a plurality of swing positions in the golf swing to serve as the motion information.

14. The golf teaching system according to claim 13, wherein the step of performing the recognition for the skeleton feature points for the plurality of body parts further comprises:
dividing the motion information into the plurality of stages according to characteristics of the change information of body motion and the body rotation angle information of the swing fixed points.

15. The golf teaching system according to claim 10, wherein the computing device is configured to execute a model establishing process to generate the expert model, wherein the model establishing process comprises:
obtain a plurality of starting-to-learn swing data records related to a plurality of first beginners;
configuring a labeling interface for performing a posture deviation labeling on the plurality of starting-to-learn swing data records, so as to generate training data;
training a plurality of second beginners with the training data to verify and correct the training data;
providing a plurality of reference documents and creating a semantic database with the plurality of reference documents;
associating the plurality of starting-to-learn swing data records, the labeled training data and the semantic database to generate a knowledge graph;
setting an inference model target according to a display content of the user interface; and
establishing a fuzzy rule for posture correction inference in the expert model according to the knowledge graph and the inference model target.

16. The golf teaching system according to claim 15, wherein the expert model further comprises detailed information of swing gestures corresponding to the plurality of stages in the golf swing, and the golf teaching method further comprises: configuring the computing device to obtain swing position detailed information of the swing gestures of the user by analyzing the plurality of swing images and the plurality of simulator data records, wherein the posture deviation labeling performed on the plurality of starting-to-learn swing data records by configuring the labeling interface comprises labeling of corresponding common mistakes, detailed deviations of the plurality of swing positions and the correction suggestion information.

17. The golf teaching system according to claim 10, wherein the expert model further comprises hitting point feature information corresponding to the golf swing, and the computing device is further configured to: obtain hitting point feature information during the user performing the golf swing by analyzing the plurality of swing images and the plurality of simulator data records; and compare the motion information of the user with the corresponding expert motion information and compare the hitting point feature information of the expert model with the hitting point feature information of the user in each of the plurality of stages, so as to generate the comparison result.

18. The golf teaching system according to claim 10, wherein the expert model further comprises ball path feature information corresponding to the golf swing, and the golf teaching method further comprises: configuring the computing device to extract ball path information from the plurality of simulator data records of the golf simulator, to compare the user motion information with the corresponding expert motion information in each of the plurality of stages and to compare the ball feature information of the expert model with the ball path feature information of the golf simulator, so as to generate the comparison result.
